(19) United States
(12) Patent Application Publication
(10) Pub. No.: US 2008/0144485 A1
(43) Pub. Date: Jun. 19, 2008

(54) RECEIVER CIRCUIT, ELECTRONIC INSTRUMENT, AND SIGNAL PROCESSING METHOD

(75) Inventor: Kazumi MATSUMOTO, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 11/953,588

(22) Filed: Dec. 10, 2007

(30) Foreign Application Priority Data
Dec. 13, 2006 (JP) 2006-335453

(51) Int. Cl. H04J 15/00; G01S 1/00

(52) U.S. Cl. 370/201; 342/357.01

(57) ABSTRACT

A signal received by an antenna or the like is input from an input terminal, and is amplified by an amplifier section together with thermal noise superimposed on the received signal. An addition section adds the signal amplified by the amplifier section to a cancellation signal generated by a cancellation signal generation section, whereby the noise superimposed on the received signal is canceled.

Japanese Patent Application No. 2006-335453 filed on Dec. 13, 2006, is hereby incorporated by reference in its entirety.

### BACKGROUND OF THE INVENTION

The present invention relates to a receiver circuit, an electronic instrument, and a signal processing method.

A phenomenon called crosstalk is known in which a signal of one channel is superimposed on another channel. This phenomenon typically occurs in a receiver. Since crosstalk causes significant deterioration in a signal, various technologies have been proposed which prevent crosstalk or remove the mixed crosstalk component.

For example, U.S. Pat. No. 7,050,388 discloses technology which removes a crosstalk component by generating a signal which cancels the mixed crosstalk component (hereinafter referred to as “cancellation signal”).

In an electronic instrument including a receiver circuit, an alternating current signal may be generated due to a change in electromagnetic field accompanying the circuit operation of an electronic circuit disposed near the receiver circuit. The alternating current signal may be transmitted to the receiver circuit and mixed into a received signal as an interference wave. In this case, the interference wave superimposed on the received signal may be attenuated and removed by generating a cancellation signal which cancels the signal generated by the electronic circuit from the generated signal and adding the cancellation signal to the received signal utilizing the technology disclosed in U.S. Pat. No. 7,050,388.

As noise to be superimposed on the signal in the receiver circuit, white noise (generally called thermal noise) predominantly occurs. Therefore, if the cancellation signal for the signal generated by the electronic circuit is merely added to the received signal, the thermal noise cannot be canceled, although the interference wave can be canceled. Moreover, since the thermal noise superimposed on the cancellation signal is added to the thermal noise superimposed on the received signal, the SN ratio of the received signal deteriorates to a large extent.

### SUMMARY

According to one aspect of the invention, there is provided a receiver circuit comprising:

an amplifier section that amplifies a signal received by a reception section together with thermal noise;

a cancellation signal generation section that generates a cancellation signal, the cancellation signal cancelling a signal generated by an electronic circuit disposed near the reception section; and

an addition section that adds the cancellation signal generated by the cancellation signal generation section to the signal amplified by the amplifier section,

the cancellation signal generation section generating the cancellation signal while changing an amplitude of the cancellation signal based on the signal obtained due to the addition by the addition section.

### BRIEF DESCRIPTION OF THE SEVERAL VIEWS OF THE DRAWING

FIG. 1 is a block diagram showing the configuration of a receiver circuit.

FIG. 2 is a block diagram showing the configuration of a cancellation signal generation section.

FIG. 3 is a view illustrative of the interference wave removal principle.

FIG. 4 is a block diagram showing the configuration of a portable phone.

FIG. 5 is a block diagram showing the configuration of a portable phone according to a modification.

FIG. 6 is a block diagram showing the configuration of a portable navigation device according to a modification.

### DETAILED DESCRIPTION OF THE EMBODIMENT

According to one embodiment of the invention, there is provided a receiver circuit comprising:

an amplifier section that amplifies a signal received by a reception section together with thermal noise;

a cancellation signal generation section that generates a cancellation signal, the cancellation signal cancelling a signal generated by an electronic circuit disposed near the reception section; and

an addition section that adds the cancellation signal generated by the cancellation signal generation section to the signal amplified by the amplifier section,

the cancellation signal generation section generating the cancellation signal while changing an amplitude of the cancellation signal based on the signal obtained due to the addition by the addition section.

According to the above configuration, after the received signal has been amplified by the amplifier section together with thermal noise, the addition section adds the resulting signal to the cancellation signal generated by the cancellation signal generation section, whereby the noise superimposed on the received signal is canceled.

The level of the thermal noise superimposed on the received signal increases due to amplification by the amplifier section. However, since the signal component is also amplified to the same extent, the SN ratio does not deteriorate due to the amplification. When the amplification factor is sufficiently large, the level of the thermal noise superimposed on the received signal becomes significantly higher than the level of the thermal noise superimposed on the cancellation signal. Therefore, an increase in thermal noise due to the addition of the cancellation signal by the addition section can be substantially disregarded. As a result, the ratio of the signal component to the noise component (excluding the thermal noise component) of the addition result signal is significantly increased.

According to another embodiment of the invention, there is provided a signal processing method comprising:

amplifying a signal received by a reception section together with thermal noise;

generating a cancellation signal that cancels a signal generated by an electronic circuit disposed near the reception section; and

adding the cancellation signal to the amplified signal,

the generating of the cancellation signal including generating the cancellation signal while changing an amplitude of the cancellation signal based on the signal obtained due to the addition.

In the receiver circuit,

the cancellation signal generation section may include:

a phase shifter section that shifts a phase of the signal generated by the electronic circuit by 180 degrees; and

an attenuation section that attenuates the signal phase-shifted by the phase shifter section by an attenuation factor corresponding to the signal obtained due to the addition by the addition section.

According to the above configuration, the cancellation signal generation section shifts the phase of the signal generated by the electronic circuit by 180 degrees, and attenuates the phase-shifted signal by an attenuation factor corresponding to the signal obtained due to the addition by the addition section. A cancellation signal which appropriately cancels noise superimposed on the received signal can be generated by employing a configuration in which the attenuation factor is changed based on the signal obtained due to the addition.

In the signal processing method,

the generating of the cancellation signal may include:

shifting a phase of the signal generated by the electronic circuit by 180 degrees; and

attenuating the phase-shifted signal by an attenuation factor corresponding to the signal obtained due to the addition.

In the receiver circuit,

the cancellation signal generation section may include a filter that allows a signal in the same band as a frequency band of the received signal to pass through, the signal in the same band as the frequency band of the received signal being contained in the signal generated by the electronic circuit; and

the phase shifter section may shift a phase of the signal that has passed through the filter.

According to the above configuration, the cancellation signal generation section filters the signal generated by the electronic circuit to extract the signal in the same band as the frequency band of the received signal, and shifts the phase of the extracted signal. Therefore, a signal in a band differing from the frequency band of the received signal is attenuated and removed by the filter.

In the signal processing method,

the generating of the cancellation signal may further include extracting a signal in the same band as a frequency band of the received signal from the signal generated by the electronic circuit; and

the phase of the extracted signal may be shifted by 180 degrees.

In the receiver circuit, the attenuation section may attenuate the signal phase-shifted by the phase shifter section by an attenuation factor corresponding to a difference between a signal level of the signal obtained due to the addition by the addition section and a signal level of a specific reference signal.

According to the above configuration, the signal level of the signal obtained due to the addition by the addition section is compared with the signal level of the specific reference signal, and the signal phase-shifted by the phase shifter section is attenuated by an attenuation factor corresponding to the difference.

In the signal processing method, the attenuating may include attenuating the phase-shifted signal by an attenuation factor corresponding to a difference between a signal level of the signal obtained due to the addition and a signal level of a specific reference signal.

According to a further embodiment of the invention, there is provided an electronic instrument comprising:

the above receiver circuit; and

the electronic circuit disposed near the receiver circuit.

In the electronic instrument, the electronic circuit may include a communication circuit that performs communication in a frequency band differing from that of the signal received by the receiver circuit.

According to the above configuration, noise caused by a signal generated by the communication circuit which performs communication in a frequency band differing from that of the received signal is canceled from the signal received by the receiver circuit.

In the electronic instrument,

the receiver circuit may be a circuit that receives a satellite signal from a positioning satellite; and

the electronic circuit may be a portable phone communication circuit.

According to the above configuration, noise caused by a signal generated by the portable phone communication circuit is canceled from the satellite signal received from the positioning satellite.

Embodiments of the invention are described below with reference to the drawings. Note that the embodiments described below do not in any way limit the scope of the invention laid out in the claims. Note that all elements of the embodiments described below should not necessarily be taken as essential requirements for the invention.

A receiver circuit which constitutes the principle of the embodiments and examples to which the receiver circuit is applied are described below in that order.

### 1. Principle

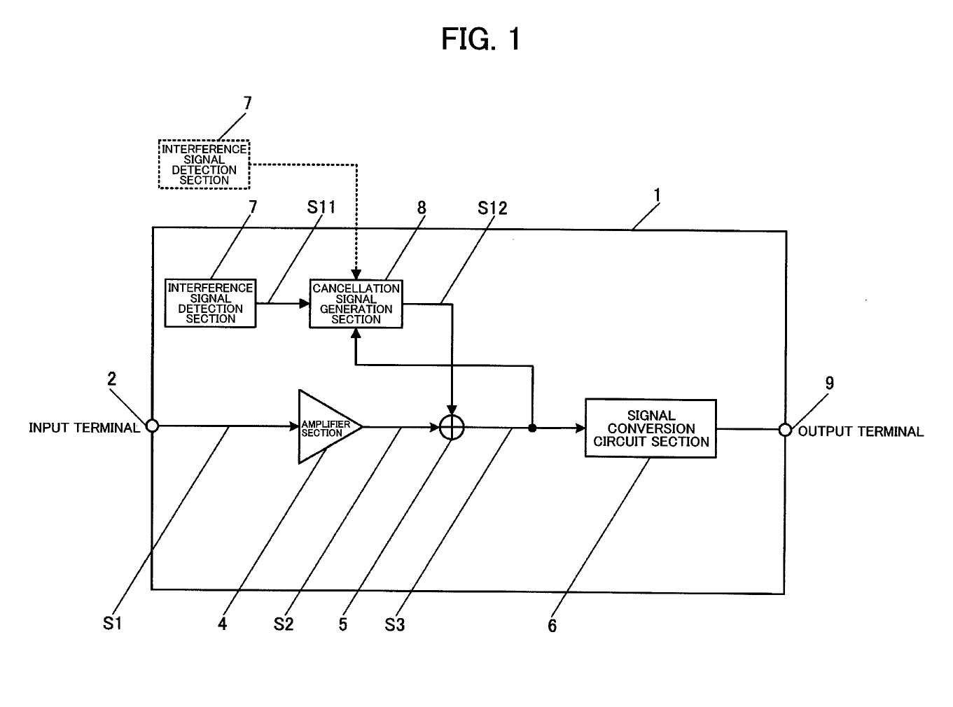

FIG. 1 is a block diagram showing the configuration of a receiver circuit 1 according to one embodiment of the invention. The receiver circuit 1 may be a circuit which receives a satellite signal from a positioning satellite represented by a global positioning system (GPS) satellite, or may be a receiver circuit for wireless communication represented by a wireless local area network (LAN) conforming to Bluetooth (registered trademark) or IEEE802.11. The receiver circuit 1 may be a receiver circuit for cable communication represented by Ethernet.

The receiver circuit 1 is a high-frequency signal (RF signal) circuit block which is configured to include an input terminal 2, an amplifier section 4, an addition section 5, a signal conversion circuit section 6, an interference signal detection section 7, a cancellation signal generation section 8, and an output terminal 9.

The input terminal 2 is a terminal which is connected with an antenna or the like and to which a signal received by the antenna or the like is input. The amplifier section 4 includes an amplifier such as a low noise amplifier (LNA). The amplifier section 4 amplifies a signal S1 input from the input terminal 2 by a specific amplification factor (gain), and outputs the amplified signal S2 to the addition section 5.

The addition section 5 is an adder which adds a cancellation signal S12 generated by the cancellation signal generation section 8 to the signal S2 amplified by the amplifier section 4. The addition section 5 outputs the addition result signal S3 to the signal conversion circuit section 6 and the cancellation signal generation section 8.

The signal conversion circuit section 6 includes a frequency conversion circuit which down-converts a high-frequency signal (RF signal) into an intermediate-frequency signal, an A/D converter which converts the signal down-converted by the frequency conversion circuit into a digital signal, and the like. The signal conversion circuit section 6 down-converts the signal S3 output from the addition section 5 into an intermediate-frequency signal, digitizes the intermediate-frequency signal, and outputs the digital signal to the output terminal 9.

The output terminal 9 is a terminal which outputs the intermediate-frequency digital signal output from the signal conversion circuit section 6 to a digital signal processing circuit section and the like connected in the subsequent stage.

The interference signal detection section 7 is a circuit section which detects noise near the receiver circuit 1 or the antenna (hereinafter collectively referred to as “reception section”) superimposed on the signal received by the reception section. The interference signal detection section 7 includes a pickup coil which detects a change in electromagnetic field near the reception section and the like. The detected change in electromagnetic field is output to the cancellation signal generation section 8 as an interference signal S11. The interference signal detection section 7 may not be disposed at a fixed position inside the receiver circuit 1. The interference signal detection section 7 may be provided at an arbitrary position separated from the receiver circuit 1, and connected with the receiver circuit 1 via interconnects such as signal lines.

Since the interference signal detection section 7 is a circuit section which detects noise (change in electromagnetic field) superimposed on the signal received by the reception section, the detection target of a change in electromagnetic field may be an arbitrary electronic circuit. For example, the detection target may be a communication circuit of a portable phone, a wireless LAN, or the like, a processor such as a CPU, a circuit of a liquid crystal display device, or the like. Since it is necessary to detect a change in electromagnetic field which serves as an interference wave for the received signal, it is desirable that the detection target be an electronic circuit positioned near the reception section.

The cancellation signal generation section 8 is a circuit section which shifts the phase of the interference signal S11 output from the interference signal detection section 7 by 180 degrees, and variably attenuates the amplitude of the resulting signal based on the output signal S3 from the addition section 5 to generate the cancellation signal S12.

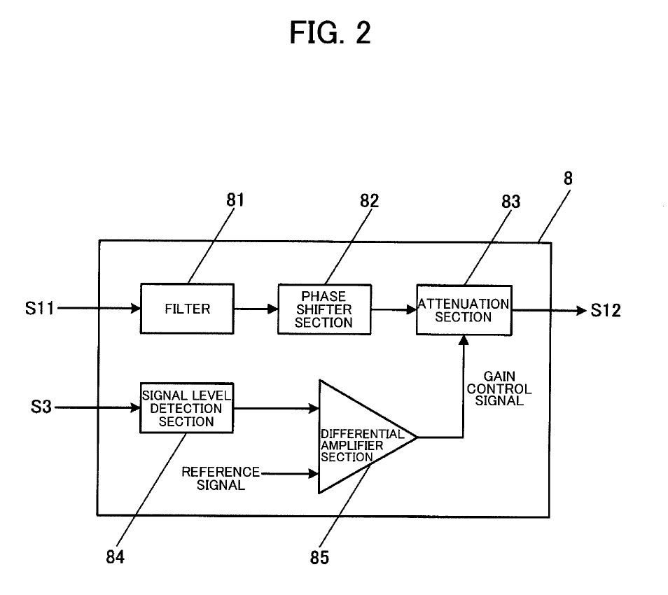

FIG. 2 is a view showing an example of the circuit configuration of the cancellation signal generation section 8. The cancellation signal generation section 8 is configured to include a filter 81, a phase shifter section 82, an attenuation section 83, a signal level detection section 84, and a differential amplifier section 85.

The filter 81 is a bandpass filter which allows a signal in the same band (hereinafter referred to as “in-band”) as the frequency band of the received signal to pass through. The filter 81 attenuates and removes a signal in a band (hereinafter referred to as “out-band”) outside the frequency band of the received signal from the interference signal S11 detected by the interference signal detection section 7.

The phase shifter section 82 is a phase shifter circuit including a delay element and the like. The phase shifter section 82 shifts the phase of the signal which has passed through the filter 81 by 180 degrees, and outputs the resulting signal to the attenuation section 83.

The attenuation section 83 is a variable attenuator which attenuates the signal output from the phase shifter section 82 by an attenuation factor corresponding to an attenuation factor (gain) control signal (hereinafter referred to as “gain control signal”) output from the differential amplifier section 85, and outputs the attenuated signal to the addition section 5 as the cancellation signal S12.

The signal level detection section 84 is a circuit section including a known signal level detection circuit. The signal level detection section 84 detects the signal level (electric power) of the signal S3 output from the addition section 5, and outputs the detected signal level to the differential amplifier section 85.

The differential amplifier section 85 is a known differential amplifier circuit including an operational amplifier and the like. The differential amplifier section 85 compares the signal level of the signal S3 detected by the signal level detection section 84 with the signal level of a reference signal, and outputs a signal corresponding to the difference to the attenuation section 83 as the gain control signal. The reference signal is generated by dividing a specific voltage, for example.

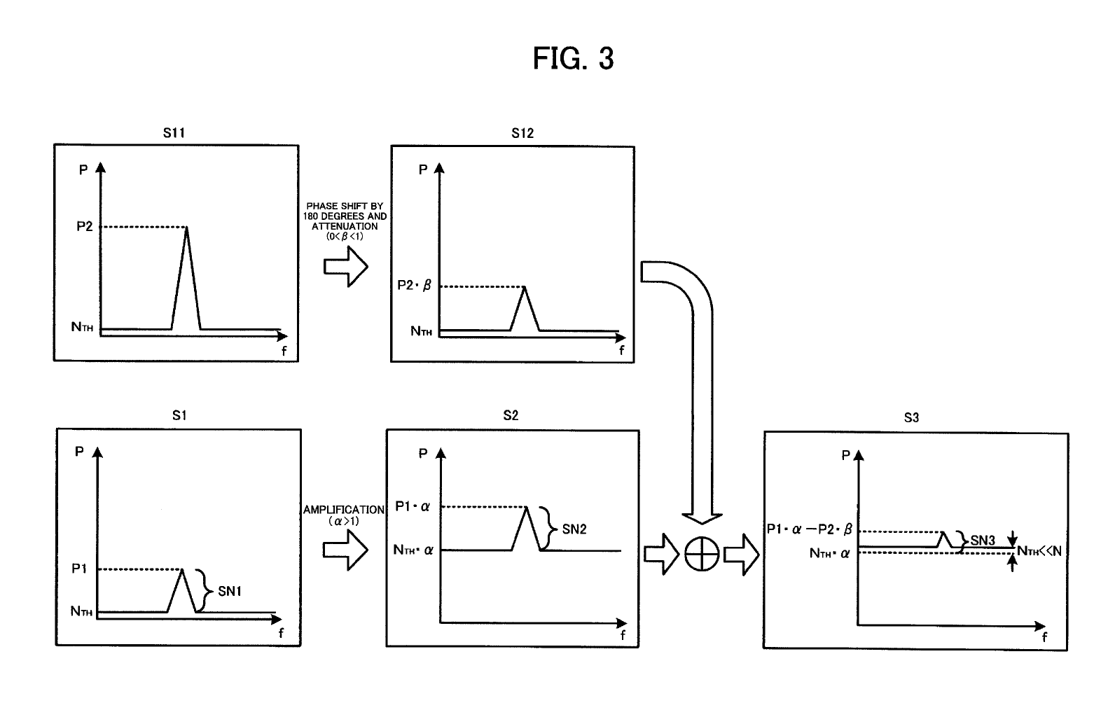

FIG. 3 is a view illustrative of the interference wave removal principle according to this embodiment. In FIG. 3, the horizontal axis indicates frequency (f), and the vertical axis indicates signal level (P). FIG. 3 schematically shows the frequency spectra of the signals S1, S2, S3, S11, and S12 in FIG. 1. Note that only the in-band signal is shown and described for convenience of illustration.

Various types of noise are superimposed on the signal component of the signal S1. The noise mainly includes thermal noise which is predominant noise over the entire frequency region, and an interference wave for the signal component. In FIG. 3, the level of the thermal noise is indicated by N_{TH}, and the in-band signal level of the signal S1 is indicated by P1. Therefore, the thermal noise and the interference wave are superimposed on the in-band signal component of the signal S1. The in-band SN ratio excluding the level N_{TH} of the thermal noise is the ratio SN1 of the signal component to the noise component (interference wave).

A signal obtained by amplifying the signal S1 using the amplifier section 4 is the signal S2. Since the entire signal S1 including the thermal noise is amplified, the in-band signal level has increased to P1·α, and the level of the thermal noise has increased to N_{TH}·α (α>1). The in-band SN ratio of the signal S2 excluding the thermal noise is equal to the ratio SN1 since the signal component and the noise component (interference wave) have been amplified by α.

Since the thermal noise due to the signal path is also superimposed on the interference signal S11 detected by the interference signal detection section 7, the thermal noise with the level N_{TH} is superimposed on the interference signal S11.

The interference signal S11 is extracted by the filter 81 of the cancellation signal generation section 8 only in the in-band, is aphase-shifted by the phase shifter section 82 by 180 degrees, and is attenuated by the attenuation section 83 to obtain the cancellation signal S12. Therefore, the in-band signal level of the interference signal S11 is attenuated from P2 to P2·β (0<β<1).

In this case, the level of the thermal noise superimposed on the cancellation signal S12 does not become N_{TH}·β. This is because the thermal noise is noise (noise floor) with the lowest level superimposed on the signal transmitted through the signal path. Therefore, the thermal noise superimposed on the cancellation signal S12 remains at the level N_{TH}.

The addition section 5 then adds the signal S2 amplified by the amplifier section 4 to the cancellation signal S12 generated by the cancellation signal generation section 8 to obtain the signal S3. The signal S3 is output to the signal conversion circuit section 6. In this case, since the phase of the signal S2 is the reverse of that of the cancellation signal S12, the in-band signal level of the signal S3 is the difference “P1α·P2·β” between the in-band signal level P1·α of the signal S2 and the in-band signal level P2·β of the cancellation signal S12.

The level of the thermal noise superimposed on the signal S3 is (α+1)N_{TH} (=N_{TH}·α+N_{TH}) since the thermal noise N_{TH} of the cancellation signal S12 is added to the thermal noise N_{TH}·α of the signal S2. However, when the gain α of the amplifier section 4 is sufficiently large (α>>1), N_{TH}·α+N_{TH} is almost equal to N_{TH}·α. Therefore, an increase in thermal noise due to the addition of the cancellation signal S12 can be disregarded.

The in-band SN ratio excluding the level N_{TH}·α of the thermal noise is equal to the ratio SN3 of the signal component to the noise component (interference wave). Since the interference wave has been attenuated and removed due to the addition of the cancellation signal S12, the in-band SN ratio is significantly improved as compared with the ratios SN1 and SN2 of the signal component to the noise component (interference wave) of the signals S1 and S2.

The cancellation signal generation section 8 adjusts the attenuation factor of the attenuation section 83 based on the signal S3 after the noise cancellation signal S12 has been added by the addition section 5. An electronic circuit provided near the reception section does not necessarily always perform a constant circuit operation, and may appropriately change the circuit operation depending on the operation/suspension and the like. According to the receiver circuit 1, the attenuation factor can be adjusted by feeding back the noise cancellation result. Therefore, even if the signal level of the interference signal S11 has changed, a cancellation signal with an appropriate signal level can be appropriately generated.

### 2. Example

An example in which the above receiver circuit 1 is applied to a portable phone (electronic instrument) having a navigation function is described below.

2-1. Configuration

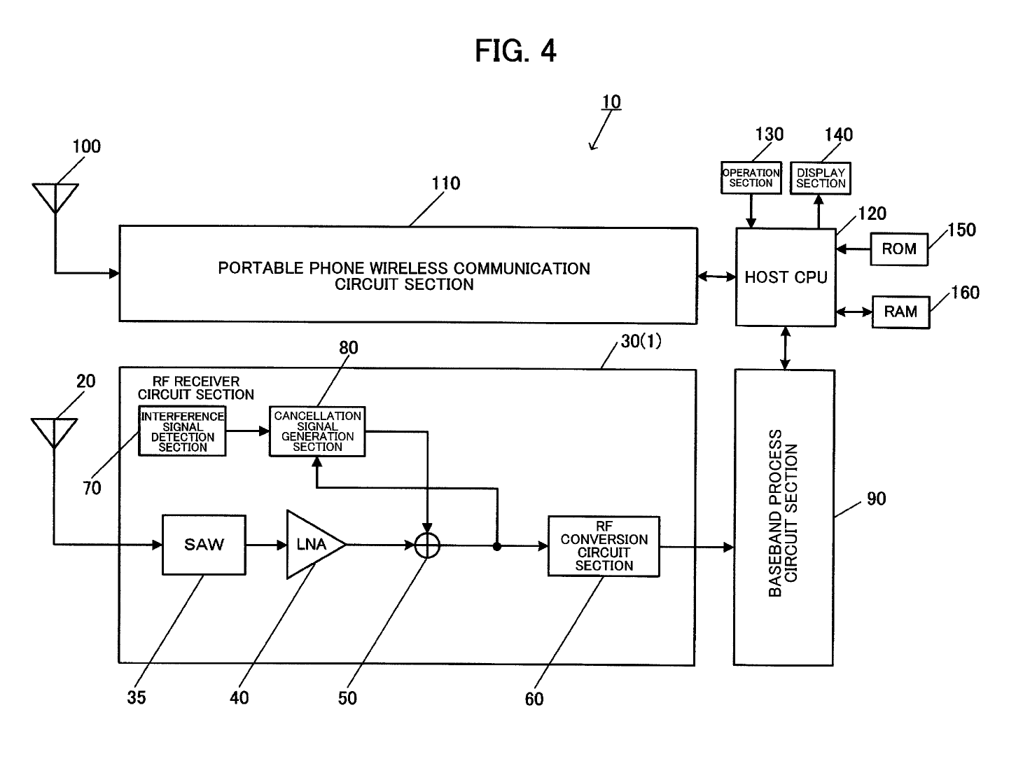

FIG. 4 is a block diagram showing the functional configuration of a portable phone 10 according to this example. The portable phone 10 is configured to include a GPS antenna 20, an RF receiver circuit section 30, a baseband process circuit section 90, a portable phone antenna 100, a portable phone wireless communication circuit section 110, a host central processing unit (CPU) 120, an operation section 130, a display section 140, a read only memory (ROM) 150, and a random access memory (RAM) 160.

The RF receiver circuit section 30 and the baseband process circuit section 90 may be manufactured as different large scale integrated (LSI) circuits, or may be manufactured in one chip.

The GPS antenna 20 is an antenna which receives an RF signal including a GPS satellite signal transmitted from a GPS satellite, and outputs the received RF signal to the RF receiver circuit section 30.

The RF receiver circuit section 30 is configured to include a surface acoustic wave (SAW) filter 35, an LNA 40, an addition section 50, an RF conversion circuit section 60, an interference signal detection section 70, and a cancellation signal generation section 80. The RF receiver circuit section 30 is a circuit block corresponding to the receiver circuit 1 shown in FIG. 1, in which the SAW filter 35 is provided between the GPS antenna 20 and the LNA 40.

The SAW filter 35 is a bandpass filter which allows a specific frequency band component of a signal output from the GPS antenna 20 to pass through, and outputs the signal which has passed through the SAW filter 35 to the LNA 40.

The LNA 40 is a low-noise amplifier which amplifies a signal S2 which has passed through the SAW filter 35, and outputs the amplified signal to the addition section 50. The LNA 40 corresponds to the amplifier section 4 shown in FIG. 1.

The addition section 50 is an adder which adds the signal amplified by the LNA 40 to a cancellation signal generated by the cancellation signal generation section 80. The addition section 50 outputs the addition result signal to the RF conversion circuit section 60 and the cancellation signal generation section 80. The addition section 50 corresponds to the addition section 5 shown in FIG. 1.

The RF conversion circuit section 60 divides or multiplies the frequency of a specific oscillation signal to generate an RF signal multiplication oscillation signal, and multiplies the generated oscillation signal by the signal output from the addition section 50 to down-convert the RF signal to an intermediate-frequency signal (hereinafter referred to as “IF signal”). After subjecting the IF signal to amplification and the like, the RF conversion circuit section 60 converts the IF signal into a digital signal using an A/D converter, and outputs the resulting digital signal to the baseband process circuit section 90. The RF conversion circuit section 60 corresponds to the signal conversion circuit section 6 shown in FIG. 1.

The interference signal detection section 70 is a circuit section which detects noise (change in electromagnetic field) near the GPS antenna 20 or the RF receiver circuit section 30 (hereinafter collectively referred to as “GPS reception section”) superimposed on the signal received by the GPS reception section. The interference signal detection section 70 outputs the detected change in electromagnetic field to the cancellation signal generation section 80 as an interference signal. The interference signal detection section 70 corresponds to the interference signal detection section 7 shown in FIG. 1.

The cancellation signal generation section 80 corresponds to the cancellation signal generation section 8 shown in FIG. 1. The cancellation signal generation section 80 is configured to include a filter, a phase shifter section, an attenuation section, a signal level detection section, and a differential amplifier section in the same manner as the cancellation signal generation section 8. The cancellation signal generation section 80 shifts the phase of the interference signal output from the interference signal detection section 70 by 180 degrees, variably attenuates the amplitude of the resulting signal based on the output signal from the addition section 50, and outputs the resulting signal to the addition section 50 as a cancellation signal.

The baseband process circuit section 90 is a circuit section which acquires/extracts a GPS satellite signal by performing a correlation detection process and the like for the IF signal output from the RF conversion circuit section 60, decodes the data to acquire a navigation message, time information, and the like, and performs pseudo-range calculations, positioning calculations, and the like. The GPS satellite signal is a spread spectrum modulated signal called a coarse and acquisition (C/A) code.

The portable phone antenna 100 is an antenna which transmits and receives a portable phone radio signal between the portable phone antenna 100 and a radio base station installed by a portable phone communication service provider.

The portable phone wireless communication circuit section 110 is a portable phone communication circuit including an RF conversion circuit, a baseband process circuit, and the like. The portable phone wireless communication circuit section 110 implements a telephone call, e-mail transmission/reception, and the like by performing demodulation/modulation of the portable phone radio signal and the like.

Since an electronic circuit including the portable phone antenna 100 and the portable phone wireless communication circuit section 110 (hereinafter referred to as “portable phone electronic circuit”) is provided in the portable phone 10, the portable phone electronic circuit is disposed at a position near the GPS reception section. Therefore, the portable phone electronic circuit generates an alternating current signal due to a change in electromagnetic field caused by its circuit operation. The interference signal detection section 70 detects a change in electromagnetic field near the GPS reception section caused by the circuit operation of the portable phone electronic circuit as an interference signal.

The host CPU 120 is a processor which controls each section of the portable phone 10 based on various programs such as a system program stored in the ROM 150. The host CPU 120 mainly controls the telephone function, and causes the display section 140 to display a navigation screen in which the present position of the portable phone 10 located by the baseband process circuit section 90 is plotted.

The operation section 130 is an input device including an operation key, a button switch, and the like. The operation section 130 outputs a press signal to the host CPU 120. Various instruction inputs such as a telephone call request and a navigation screen display request are performed by operating the operation section 130.

The display section 140 is a display device which includes a liquid crystal display (LCD) or the like, and displays various images based on a display signal input from the host CPU 120. The display section 140 displays date and time information, a navigation screen, and the like.

The ROM 150 is a read-only storage device, and stores data and various programs such as a system program for controlling the portable phone 10, a program for implementing a telephone call and e-mail transmission/reception, and a program for implementing the navigation function. The host CPU 120 performs a process based on these programs and data.

The RAM 160 is a readable/writable storage device. The RAM 160 serves as a work area which temporarily stores the system program executed by the host CPU 120, various processing programs, data processed during various processes, processing results, and the like.

2-2. Operation

The frequency of the GPS satellite signal is 1.57542 GHz. On the other hand, the frequency of the portable phone radio signal is 0.8 GHz, 1.7 GHz, 2.0 GHz, or the like depending on the communication method. Therefore, the side-lobe signal of the portable phone radio signal is superimposed on the received GPS satellite signal as an in-band interference wave.

When a signal is output from the GPS antenna 20 to the RF receiver circuit section 30, the SAW filter 35 allows a signal in a specific band around the in-band of the GPS satellite signal to pass through. Specifically, a signal around the in-band is mainly extracted by the SAW filter 35.

The LNA 40 amplifies the signal output from the SAW filter 35 by a gain α, and outputs the resulting signal to the addition section 50.

The interference signal detection section 70 detects a change in electromagnetic field near the GPS reception section, and outputs the detection result to the cancellation signal generation section 80 as an interference signal. Specifically, the interference signal detection section 70 detects the portable phone radio signal transmitted and received by the portable phone wireless communication circuit section 110 via the portable phone antenna 100 as the main interference signal.

In the cancellation signal generation section 80, the filter extracts a signal component in the in-band of the GPS satellite signal from the interference signal containing the portable phone radio signal as the main component. The phase shifter section shifts the phase of the interference signal which has passed through the filter by 180 degrees. The attenuation section attenuates the interference signal by a gain β, and outputs the resulting signal to the addition section 50 as a cancellation signal.

The addition section 5 then adds the cancellation signal generated by the cancellation signal generation section 80 to the signal amplified by the LNA 40. As a result, the in-band interference wave for the GPS satellite signal (i.e., side-lobe signal of the portable phone radio signal superimposed on the in-band of the GPS satellite signal) is attenuated and removed. The addition section 50 then outputs the addition result signal to the RF conversion circuit section 60 and the cancellation signal generation section 80.

The cancellation signal generation section 80 adjusts the signal level of the cancellation signal to be generated depending on the signal level of the signal obtained after the addition of the cancellation signal by the addition section 50. This realizes appropriate noise cancellation following the level of the interference signal which changes depending on the circuit operation of the portable phone electronic circuit.

The level of the thermal noise superimposed on the signal received by the GPS antenna 20 increases due to amplification by the LNA 40. However, since the signal component is amplified to the same extent, the SN ratio does not deteriorate due to the amplification. When the gain of the LNA 40 is sufficiently large, the level of the thermal noise superimposed on the received signal becomes significantly higher than the level of the thermal noise superimposed on the cancellation signal. Therefore, an increase in thermal noise due to the addition of the cancellation signal by the addition section 50 can be substantially disregarded. Since the interference wave component of the received signal is attenuated and removed by the addition of the cancellation signal, the ratio of the signal component of the signal obtained after the addition of the cancellation signal to the noise component (excluding the thermal noise component) can be increased to a large extent.

### 3. Other Examples

### 3-1. Application Example

The invention may be applied to various electronic instruments such as a portable navigation device, a car navigation system, and a personal computer (PC) in addition to the portable phone. Specifically, the invention may be applied to an electronic instrument including a receiver circuit which receives a signal and an electronic circuit which causes a change in electromagnetic field as an interference wave (noise) for the received signal.

As the receiver circuit, various communication circuits and the like may be applied in addition to the GPS signal receiver circuit. As the electronic circuit which is disposed near the reception section and generates an interference wave for the receiver circuit, a computer system, various communication circuits, and the like may be applied. Note that it is desirable that the reception frequency of the receiver circuit be close to the frequency of the signal generated by the electronic circuit.

### 3-2. Satellite Positioning System

The above example has been described taking a GPS as an example of the satellite positioning system. Note that the invention may also be applied to other satellite positioning systems such as WAAS, QZSS, GLONASS, and GALILEO.

### 3-3. Input of Interference Signal

The above embodiment has been described taking an example in which noise near the reception section is detected by disposing the interference signal detection section 7 at a fixed position inside the receiver circuit 1. Note that a configuration may also be employed in which the interference signal detection section 7 is not disposed.

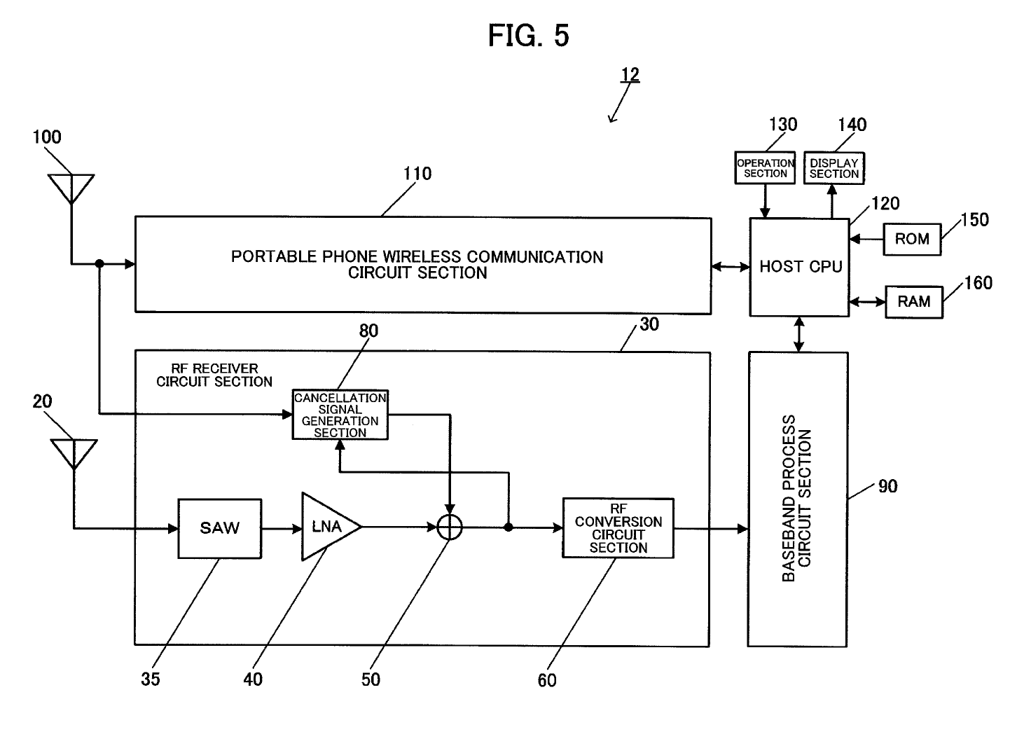

FIG. 5 is a block diagram showing a configuration example of a portable phone 12 in this case. Note that the same elements as the elements of the portable phone 10 are indicated by the same symbols. Description of these elements is omitted. The portable phone 12 is configured so that a signal line connected to the cancellation signal generation section 80 is provided from the middle of a signal line which connects the portable phone antenna 100 and the portable phone wireless communication circuit section 110, whereby a signal generated by the portable phone electronic circuit is directly input to the cancellation signal generation section 80. In this case, since the interference signal detection section 70 becomes unnecessary, the degree of freedom relating to the layout inside the housing can be increased. Moreover, the cancellation signal can be reliably generated using the portable phone radio signal as the interference signal.

### 3-4. Interference Signal Detection Section

A configuration may also be employed in which the interference signal detection section 7 is provided at a position separated from the receiver circuit 1 instead of disposing the interference signal detection section 7 in the receiver circuit 1 and is connected with the receiver circuit 1 via interconnects such as signal lines.

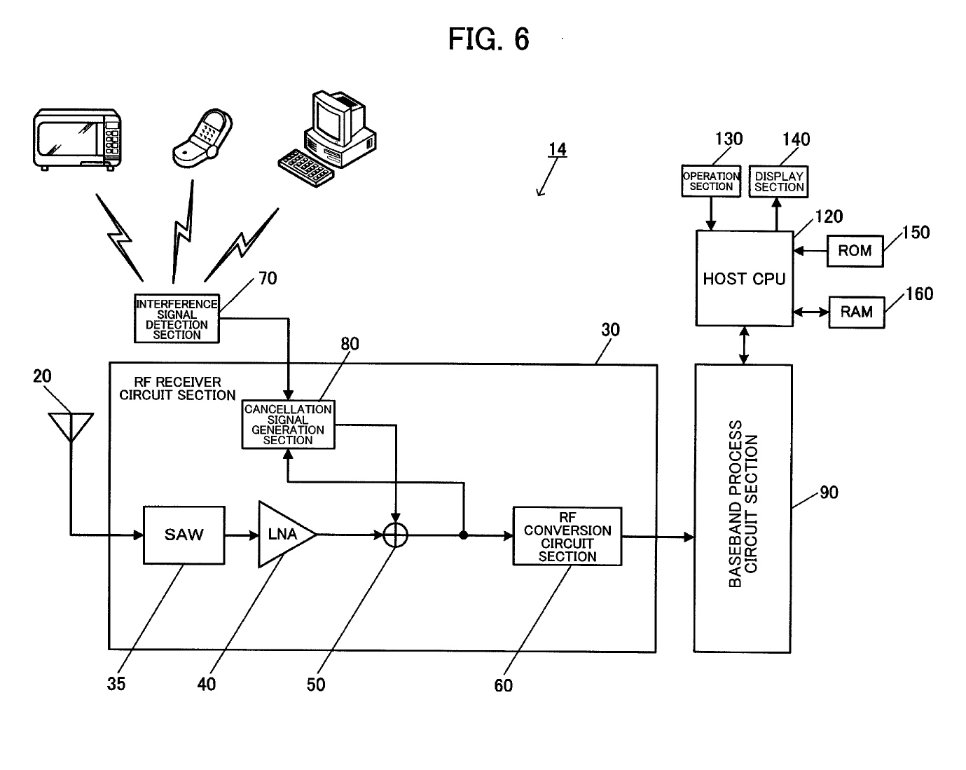

FIG. 6 shows an example of a block diagram when applying the above configuration to a portable navigation device 14. The portable navigation device 14 is a portable electronic instrument (e.g., GPS wristwatch) having a navigation function. Note that the same elements as the elements of the portable phone 10 are indicated by the same symbols. Description of these elements is omitted.

In the portable navigation device 14, the interference signal detection section 70 is disposed outside the housing, and is connected with the cancellation signal generation section 80 via a signal line. The interference signal detection section 70 may or may not be integrated with the housing. The interference signal detection section 70 detects signals generated by various electronic instruments such as a microwave oven, a portable phone, and a PC, and outputs the detection result to the cancellation signal generation section 80. According to this configuration, even if an interference signal source exists near the device, the cancellation signal can be reliably generated by detecting the interference signal, whereby an interference wave superimposed on the received signal can be canceled.

Although only some embodiments of the invention have been described above in detail, those skilled in the art would readily appreciate that many modifications are possible in the embodiments without materially departing from the novel teachings and advantages of the invention. Accordingly, such modifications are intended to be included within the scope of the invention.

What is claimed is:

1. A receiver circuit comprising:
an amplifier section that amplifies a signal received by a reception section together with thermal noise;
a cancellation signal generation section that generates a cancellation signal, the cancellation signal cancelling a signal generated by an electronic circuit disposed near the reception section; and
an addition section that adds the cancellation signal generated by the cancellation signal generation section to the signal amplified by the amplifier section,
the cancellation signal generation section generating the cancellation signal while changing an amplitude of the cancellation signal based on the signal obtained due to the addition by the addition section.

2. The receiver circuit as defined in claim 1,
the cancellation signal generation section including:
a phase shifter section that shifts a phase of the signal generated by the electronic circuit by 180 degrees; and
an attenuation section that attenuates the signal phase-shifted by the phase shifter section by an attenuation factor corresponding to the signal obtained due to the addition by the addition section.

3. The receiver circuit as defined in claim 2,
the cancellation signal generation section including a filter that allows a signal in the same band as a frequency band of the received signal to pass through, the signal in the same band as the frequency band of the received signal being contained in the signal generated by the electronic circuit; and
the phase shifter section shifting a phase of the signal that has passed through the filter.

4. The receiver circuit as defined in claim 2, the attenuation section attenuating the signal phase-shifted by the phase shifter section by an attenuation factor corresponding to a difference between a signal level of the signal obtained due to the addition by the addition section and a signal level of a specific reference signal.

5. An electronic instrument comprising:
the receiver circuit as defined in claim 1; and
the electronic circuit disposed near the receiver circuit.

6. The electronic instrument as defined in claim 5, the electronic circuit including a communication circuit that performs communication in a frequency band differing from that of the signal received by the receiver circuit.

7. The electronic instrument as defined in claim 5,
the receiver circuit being a circuit that receives a satellite signal from a positioning satellite; and
the electronic circuit being a portable phone communication circuit.

8. A signal processing method comprising:
amplifying a signal received by a reception section together with thermal noise;
generating a cancellation signal that cancels a signal generated by an electronic circuit disposed near the reception section; and
adding the cancellation signal to the amplified signal,
the generating of the cancellation signal including generating the cancellation signal while changing an amplitude of the cancellation signal based on the signal obtained due to the addition.

9. The signal processing method as defined in claim 8,
the generating of the cancellation signal including:
shifting a phase of the signal generated by the electronic circuit by 180 degrees; and
attenuating the phase-shifted signal by an attenuation factor corresponding to the signal obtained due to the addition.

10. The signal processing method as defined in claim 9,
the generating of the cancellation signal further including extracting a signal in the same band as a frequency band of the received signal from the signal generated by the electronic circuit; and
the phase of the extracted signal being shifted by 180 degrees.

11. The signal processing method as defined in claim 9, the attenuating including attenuating the phase-shifted signal by an attenuation factor corresponding to a difference between a signal level of the signal obtained due to the addition and a signal level of a specific reference signal.
